(19) United States
(12) Patent Application Publication
(10) Pub. No.: US 2026/0169971 A1
(43) Pub. Date: Jun. 18, 2026

(54) SYSTEM FOR COLLECTING AND MANAGING PUBLIC STATISTICAL DATA IN RESOURCE-CONSTRAINED ENVIRONMENT AND METHOD OF COLLECTING AND MANAGING PUBLIC STATISTICAL DATA USING THE SAME

(71) Applicant: ELECTRONICS AND TELECOMMUNICATIONS RESEARCH INSTITUTE, Daejeon (KR)

(72) Inventor: Tae Hwan Kim, Daejeon (KR)

(21) Appl. No.: 19/361,482

(22) Filed: Oct. 17, 2025

(30) Foreign Application Priority Data
Dec. 13, 2024 (KR) 10-2024-0185784

(51) Int. Cl. G06F 16/22; G06F 9/54; G06F 16/2458

(52) U.S. Cl. CPC G06F 16/2282; G06F 9/544; G06F 16/2462

(57) ABSTRACT

Disclosed are a system and method for collecting and managing public statistical data in a resource-constrained environment. The system for collecting and managing public statistical data in a resource-constrained environment includes a central controller configured to process a system request and to set a control path within the system, a data collection unit configured to collect data from an open data source and to generate statistical data information by analyzing a response, a data storage unit configured to store a statistical data object in a data storage registry, and a data management unit configured to perform data management based on a system request and to manage a data management registry.

### CROSS-REFERENCE TO RELATED APPLICATION

This application claims priority to and the benefit of Korean Patent Application No. 10-2024-0185784 filed on Dec. 13, 2024, the disclosures of which are incorporated herein by reference in their entirety.

### BACKGROUND

### 1. Technical Field

The present disclosure relates to a system and method for collecting and managing public statistical data in a resource-constrained environment.

### 2. Description of Related Art

Open data sources have a complex and sophisticated meta data definition system in order to manage massive amounts of statistical data. Accordingly, the open data sources have a problem in that it is difficult to collect and manage meta data in terms of the collection and management of data in a resource-constrained environment, such as edge computing, require an interpretation process for meta data, and have a problem in that it is difficult to implement a system that collects data by using the API of an open data source through single logic.

### SUMMARY

Various embodiments are directed to providing a system and method for collecting and managing public statistical data which are provided by various open data sources in a resource-constrained environment, such as edge computing or an IoT environment, in order to provide a user with statistical data that do not require an additional data interpretation task or syntax analysis and that are in the state in which the statistical data can be immediately used.

A system for collecting and managing public statistical data in a resource-constrained environment according to an embodiment of the present disclosure includes a central controller configured to process a system request and to set a control path within the system, a data collection unit configured to collect data from an open data source and to generate statistical data information by analyzing a response, a data storage unit configured to store a statistical data object in a data storage registry, and a data management unit configured to perform data management based on a system request and to manage a data management registry.

The central controller generates data and a dataflow identifier.

The central controller records the time stamp of an event within the system.

The data collection unit executes an API for collecting data from the open data source, redefines meta data through received data analysis, and performs data model conversion.

The data collection unit receives an open API including a data API and a meta data API from the central controller.

The data collection unit determines a response syntax analyzer that is fully responsible for a corresponding data source by reviewing the API.

The data collection unit constructs a statistical data model based on standard information received from the response syntax analyzer. The statistical data model includes a table in which a column header, a column value indicative of a value of attributes of data, and a statistical value corresponding to a combination of column values corresponding to each column header are stored.

The data storage unit checks and stores a table in which the statistical data object is able to be stored by reviewing a data table, returns the name of the table in which the statistical data object is stored, generates a new table in the data storage registry based on the structure of the statistical data object if a table in which the statistical data object is able to be stored is not present, and stores the statistical data object in the new table.

The data management unit performs management on the data management registry by using data and a dataflow.

The data management unit searches the data table of the data management registry for an open API by using a key in a task execution process according to a data collection request, and transmits a data object record.

The data management unit searches a dataflow table of the data management registry for a data identifier by using a key in a task execution process according to a data read request, and transmits a dataflow record.

The data management unit searches a data table of the data management registry for a data identifier by using a key in a task execution process according to a data update request, transmits a data record, and updates statistical data in the data table of the data management registry.

The data management unit searches the data table of the data management registry for a data identifier by using a key in a task execution process according to a data deletion request, transmits a data record, and deletes the data record from the data table of the data management registry by using the data identifier and a dataflow identifier by using a key.

A method of collecting and managing public statistical data in a resource-constrained environment according to an embodiment of the present disclosure includes (a) setting a control path within the system for system requests, executing an API for collecting data from an open data source, redefining meta data through received data analysis, and performing data model conversion and (b) performing processing on the system requests including data collection, read, update, and deletion and providing a response to a user.

The step (a) includes reviewing an open API including a data API and a meta data API, determining a response syntax analyzer that is to process the response, and constructing a statistical data model by using standard information received from the response syntax analyzer.

The step (b) includes searching a data table of the data management registry for the open API by using a key upon system request for the data collection, generating a data identifier for a statistical data object, and storing the statistical data object.

The step (b) includes extracting a data identifier upon system request for the data read, performing key search, extracting the name of a table from a dataflow record, and generating a response message to a read request.

The step (b) includes extracting a data identifier upon system request for the data update, performing key search, searching for a data record, checking the name of a table in a dataflow record, and updating statistical data.

The step (b) includes extracting a data identifier upon system request for the data deletion, performing key search, searching for a data record, checking the name of a table in a dataflow record, and performing record deletion by using the data identifier and the dataflow identifier as a key.

According to an embodiment of the present disclosure, it is possible to provide a user with statistical data of various open data sources having high reliability and guaranteed quality and to guarantee the up-to-date of data through periodical update setting.

According to an embodiment of the present disclosure, there are effects in that meta data that must be accompanied in a way in which a user directly requests data from an open data source are secured, a process of performing syntax analysis for statistical data can be omitted based on the secured meta data, and it is possible to support a user to immediately use data in the state in which the interpretation of the data has been completed by providing the data.

According to an embodiment of the present disclosure, it is possible to provide a system structure in which a dedicated response syntax analyzer for each data source of the data collection unit can be added and to define an output standard for a statistical data request API of the response syntax analyzer. It is possible to provide a statistical data model having maximized resource efficiency and to use the column_header_checksum that supports the use of table search for storing the statistical data model.

Effects of the present disclosure are not limited to the aforementioned effects, and other effects not described above may be evidently understood by those skilled in the art from the following description.

### BRIEF DESCRIPTION OF THE DRAWINGS

FIG. 1 illustrates an example of the meta data of a national account data set for each country.

FIG. 2 illustrates an example of an operation of a system for collecting and managing public statistical data in a resource-constrained environment according to an embodiment of the present disclosure.

FIG. 3 illustrates the system for collecting and managing public statistical data in a resource-constrained environment according to an embodiment of the present disclosure.

FIG. 4 illustrates a format for a system request and response according to an embodiment of the present disclosure.

FIG. 5 illustrates a construction of a data collection unit according to an embodiment of the present disclosure.

FIG. 6 illustrates a Public Decision-making Framework, including the Data Governance Functions (1000), Data Collect Functions (2000), Parser Distribution Functional Entity (2100), Message Parsing Functional Entity (2200), Authentication Functional Entity (2300), and Data Store Functions (3000).

FIG. 7 illustrates a statistical data model (generalized data model structure) that is constructed by a statistical data model converter based on information received from a response syntax analyzer according to an embodiment of the present disclosure.

FIG. 8 illustrates a table structure that stores the statistics of the statistical data model and fields thereof according to an embodiment of the present disclosure.

FIG. 9 illustrates a table structure of a data management registry 600 according to an embodiment of the present disclosure.

FIG. 10 illustrates a description of the fields of a data table of the data management registry according to an embodiment of the present disclosure.

FIG. 11 illustrates a description of the fields of a dataflow table of the data management registry according to an embodiment of the present disclosure.

FIG. 12 illustrates a task execution process according to a data collection request according to an embodiment of the present disclosure.

FIG. 13 illustrates a task execution process according to a data collect request.

FIG. 14 illustrates a task execution process according to a data store request.

FIG. 15 illustrates a task execution process according to a data read request according to an embodiment of the present disclosure.

FIG. 16 illustrates a task execution process according to a data update request according to an embodiment of the present disclosure.

FIG. 17 illustrates a task execution process according to a data deletion request according to an embodiment of the present disclosure.

FIG. 18 illustrates a data collection request and system response of a user scenario according to an embodiment of the present disclosure.

FIG. 19 is a block diagram illustrating a computer system for implementing a method according to an embodiment of the present disclosure.

### DETAILED DESCRIPTION

Advantages and characteristics of the present disclosure and a method for achieving the advantages and characteristics will become apparent from embodiments described in detail later in conjunction with the accompanying drawings.

However, the present disclosure is not limited to the disclosed embodiments, but may be implemented in various different forms. The embodiments are merely provided to complete the present disclosure and to fully notify a person having ordinary knowledge in the art to which the present disclosure pertains of the category of the present disclosure. The present disclosure is merely defined by the category of the claims.

Terms used in this specification are used to describe embodiments and are not intended to limit the present disclosure. In this specification, an expression of the singular number includes an expression of the plural number unless clearly defined otherwise in the context. The term “comprises” and/or “comprising” used in this specification does not exclude the presence or addition of one or more other components, steps, operations and/or components in addition to mentioned components, steps, operations and/or components.

Hereinafter, a background proposed by the present disclosure in order to help understanding of those skilled in the art, and embodiments of the present disclosure are described.

Edge computing is a technology in which computing is performed around the place where data are generated or near a user who consumes a service, and provides a real-time service to a user by reducing data transmission latency toward a central data center and a cloud server and minimizing network bandwidth requirements. Recently, new services have emerged in several fields, such as autonomous driving, a smart city, industrial automation, and healthcare, through a combination of edge computing and the artificial intelligence (AI) technology. The coverage of using edge computing is expanded to the data of various industry fields in addition to IoT sensor data.

In particular, recently, a movement of using edge computing is active because a system and a standard system capable of organizationally managing statistical data in major domestic and foreign institutions are prepared and an exchange and public method for data is established. Accordingly, there are new requirements for a system that collects and manages statistical data in order to use data having high reliability and guaranteed quality in a resource-constrained environment as in edge computing.

Standards relating to statistical data, which are currently most widely used internationally, such as statistical data and metadata exchange (SDMX) (ISO 17369:2013) and data document initiative (DDI), are operated in a way to separate data and meta data and to define the attributes and additional information of the data based on the meta data. Accordingly, meta data must be accompanied in order to use statistical data.

Representative open data sources, such as Organization for Economic Co-operation and Development (OECD), International Monetary Fund (IMF), and Korean Statistical Information Service (KOSIS), each have a complex and sophisticated meta data definition system in order to manage massive amounts of statistical data. Such a structural characteristic of the statistical data has the following problems in terms of the collection and management of data in a resource-constrained environment.

### (1) Meta Data Storage Problem in Constrained Environment

Meta data are information that defines common attributes of data including one data set. Accordingly, the size of meta data is difference depending on the size of a data set and structural characteristics of data because the meta data include the values of all of cases to which data attributes may correspond.

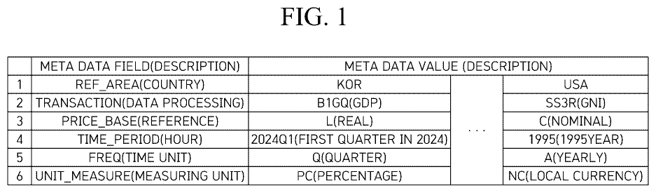

FIG. 1 illustrates an example of the meta data of a national account data set for each country. All of data included in a corresponding data set have all of meta data attributes illustrated in FIG. 1. A total size of the meta data is different depending on the application range of each attribute. For example, if a national account data set for each country includes all of indices related to economic activities, such as gross domestic product (GDP) and gross national income (GNI) of all countries in the world, the size of meta data is determined to accommodate the range of all of the indices. Furthermore, in general, the meta data also include various types of additional information, such as the constraints of data, classification information, and information on a data generator.

In general, all of the data sets of meta data are transmitted although some data of the data sets are collected because statistical data and the meta data are separately exchanged in most of open data sources. Accordingly, the collection and management of meta data is a great burden in a resource-constrained environment.

### (2) Interpretation of Data

In order to maximize transmission efficiency, in general, a data exchange message through the open API of statistical data is expressed as a code capable of identifying meta data. Information of such codes may be checked through meta data. In order to understand what a statistical value means, meta data is essentially required. Specifically, a meta data field, the code of a value, and description information of each code are required. A process of interpreting a combination of codes of a meta data value matched with each statistical datum is required.

### (3) Scalability to Various Open Data Sources

In general, an open data source provides an open API in order to supply data to a user. However, open data sources that are managed in the same standard systems, such as SDMX and DDI, are slightly different in an API message format or an exchange protocol. Furthermore, there are many open data sources in which APIs are independently managed without supporting statistical standards. Accordingly, there is a problem in that it is very difficult to practically implement a system that collects data by using the APIs of all of open data sources through single logic.

Embodiments of the present disclosure have been contrived to solve the aforementioned problems, and provide a system and method for collecting and managing public statistical data which are provided by various open data sources in a resource-constrained environment, such as edge computing or an IoT environment, in order to provide a user with statistical data which do not require an additional data interpretation task or syntax analysis and may be immediately used.

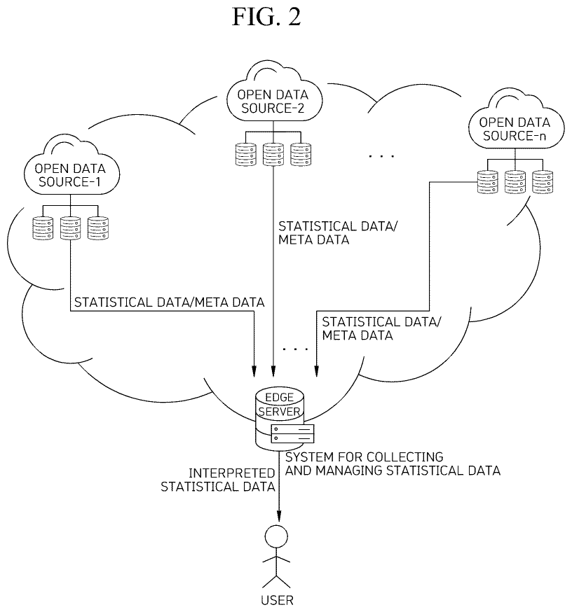

FIG. 2 illustrates an example of an operation of a system for collecting and managing public statistical data in a resource-constrained environment according to an embodiment of the present disclosure.

An embodiment of the present disclosure proposes a system designed to be extended to all of open data sources, and has an effect in that a meta data management/storage problem, a statistical data interpretation problem, and a problem related to scalability to various data sources, by redefining meta data by interpreting data and the meta data that are obtained by executing an open API, converting the meta data into an optimized data model in terms of resource efficiency, and providing a management function including the acquisition, read, update, and deletion function of data.

An embodiment of the present disclosure provides a data collection, storage, and management method for using statistical data which are provided by various public institutions and statistical institutions in a computing resource-constrained environment, such as edge computing or an IoT environment.

An embodiment of the present disclosure provides a user with a statistical data model by converting statistical data which are provided by an open data source into the statistical data model having a form in which the statistical data can be immediately used. The user may collect new data through an interface, and may request a read, update, and delete (RUD) function for statistical data that are managed in a system.

An embodiment of the present disclosure proposes a system structure to be extended to various open data sources, and provides a data management function which redefines meta data in order to store statistical data having several formats, which can convert statistical data into an optimized statistical data model in terms of resource efficiency, and which includes a periodical update and deletion function for collected data.

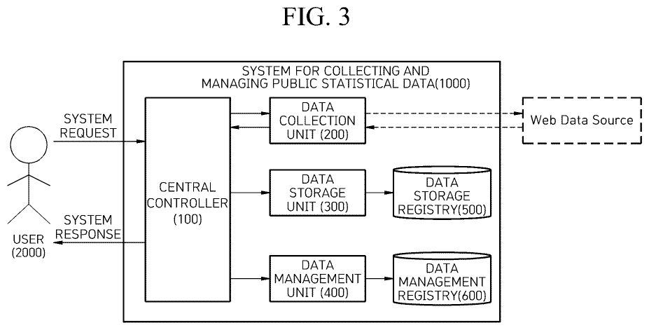

FIG. 3 illustrates the system for collecting and managing public statistical data in a resource-constrained environment according to an embodiment of the present disclosure.

The system 1000 for collecting and managing public statistical data in a resource-constrained environment according to an embodiment of the present disclosure includes a central controller 100, a data collection unit 200, a data storage unit 300, a data management unit 400, a data storage registry 500, and a data management registry 600.

### Central Controller 100

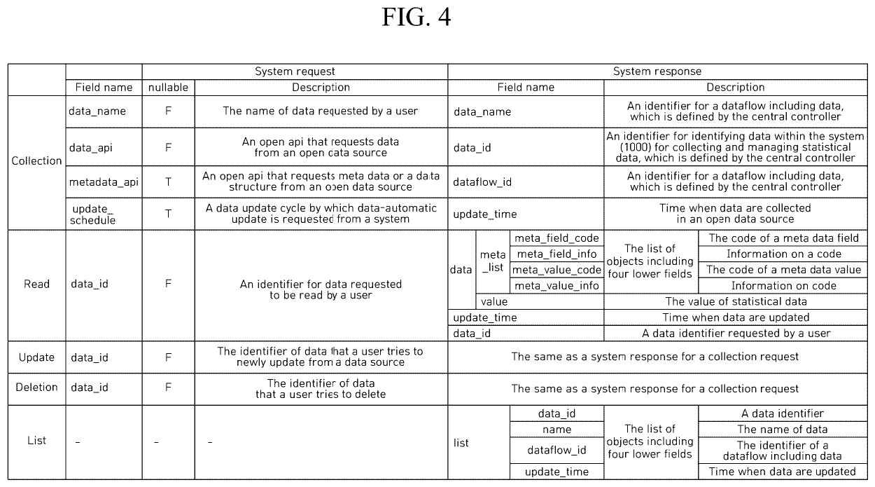

The central controller 100 processes a system request from a user and sets a control path within the system. Major functions that are performed by the central controller 100 include the processing of a system request, the setting of a control path within the system according to a system request, the generation of data and a dataflow identifier, the recording of the time stamp of an event within the system, and a periodical update task for preset data. FIG. 4 illustrates a format for a system request and response according to an embodiment of the present disclosure. A user requests data collection, read, update, and deletion from the system. FIG. 4 illustrates a description of each request and response.

### Data Collection Request

The data collection request is for performing a function for collecting specific data from an open data source. A user defines the name of data to be requested, and specifies API information on which data and meta data may be requested in fields “data_api” and “metadata_api”.

Furthermore, if periodical updates are required, an update cycle is specified in a field “update_schedule” in a time unit. If a data source does not support an API for meta data information, the field “metadata_api” is emptied. When all of procedures for a collection request are completed, the system transmits a data identifier assigned by the system, a dataflow identifier to which data belong, and a data update time as a response.

### Read Request

The read request is to request information on statistical data that are secured in the system. A data identifier is transmitted by being included in the request. The data storage unit 300 searches for statistical data stored in the data storage registry 500 based on the data identifier and returns the retrieved statistical data. The return format of the data includes a data field having a format including a meta data list “meta_list” and a statistical value, a time “update_time” when a field and data are updated in an open data source, and a data identifier “data_id”. The meta data list “meta_list” includes lower fields, such as a meta data field code “meta_field_code”, meta data field information “meta_field_info”, a meta data value code “meta_value_code”, and meta data value information “meta_value_info”.

### Data Update Request

The data update request is made to incorporate a case in which data stored in the system are updated with a new value in the original data source or to handle a situation in which new time-series data are added if a time-series range has not been set in a data collection request process. A data identifier is included in the data update request. The system responds in the same format as that of a response to the collection request when update processing is completed.

### Data Deletion Request

The data deletion request is made to delete data secured in the system. A data identifier is included in the data deletion request. When deletion processing is completed, the system responds in the same format as that of a response to the collection request.

### Data Collection Unit 200

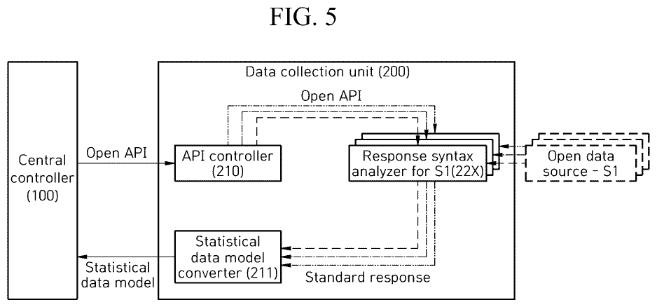

FIG. 5 illustrates a construction of the data collection unit according to an embodiment of the present disclosure.

The data collection unit 200 execute an API for collecting data from an open data source, and generates statistical data information by analyzing a received response.

The data collection unit 200 includes an API controller 210, a response syntax analyzer (illustrated as a response syntax analyzer for S1 (22X) in FIG. 5), and a statistical data model converter 211.

The API controller 210 determines a response syntax analyzer that is fully responsible for a corresponding data source by reviewing an API. That is, the API controller 210 actually executes an API by reviewing the API transmitted by the central controller 100, and determines a proper response syntax analyzer which will process a response.

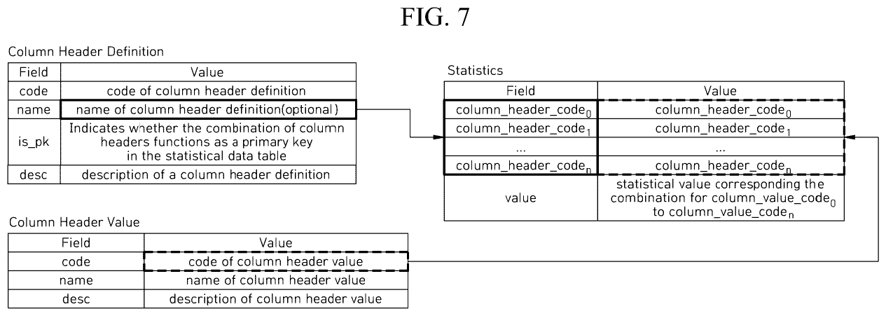

The response syntax analyzer executes an API with respect to an open data source, and extracts standardized information from a received response. The response syntax analyzer that is fully responsible for each data source is previously disposed because the API response formats of open data sources, such as OECD Data Explorer and KOSIS, are different. All of response syntax analyzers execute APIs and output standardized information by analyzing received responses. Commonly, the response syntax analyzer extracts the code of a meta data field, information on the code of the meta data field, the code of a value corresponding to the meta data field, information on the code of the value, information on a combination of meta data fields that will constitute a public key, and information in which a combination of each statistical data value and the meta data field values of the corresponding statistical data, and transmits the extracted codes and information to the statistical data model converter 211. The statistical data model converter 211 constructs a statistical data model based on standard information that is transmitted by a response syntax analyzer. FIG. 7 illustrates a statistical data model(generalized data model structure) that is constructed by the statistical data model converter based on information received from the response syntax analyzer according to an embodiment of the present disclosure. The statistical data model includes a table in which a column header indicative of the attributes of data, a column value indicative of the value of the attributes of data, and a statistical value corresponding to a combination of column values corresponding to each column header are stored, and may accommodate statistical data having various structures. Finally, the statistical data model converter 211 transmits a generated statistical data object to the central controller 100. The functions and roles of the API controller 210, response syntax analyzer 22x, and statistical data model converter 211 of the data collection unit 200 have been separated and designed. In order to extend to a new open data source, a dedicated response syntax analyzer may be added.

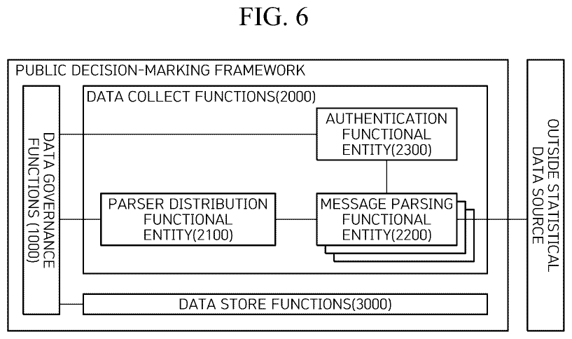

FIG. 6 illustrates a Public Decision-making Framework, including the Data Governance Functions (1000), Data Collect Functions (2000), Parser Distribution Functional Entity (2100), Message Parsing Functional Entity (2200), Authentication Functional Entity (2300), and Data Store Functions (3000).

FIG. 6 represents the functional entities within the Data Collect Functions and their interactions. The Data Collect Functions (2000) operate in conjunction with the Data Governance Functions (1000) and the Data Store Functions (3000) to ensure seamless data collection and management in a resource-constrained environment.

The Data Collect Functions (2000) are composed of the Parser Distribution Functional Entity (2100), the Authentication Functional Entity (2300), and a set of Message Parsing Functional Entities (2200) corresponding to various statistical data sources.

The Parser Distribution Functional Entity (2100) receives collect requests initiated by the Data Governance Functions (1000). Each request contains one or more APIs for retrieving raw data. The Parser Distribution Functional Entity (2100) validates these APIs and forwards them to the appropriate Message Parsing Functional Entity (2200) for execution and response parsing.

The Authentication Functional Entity (2300) manages and securely stores authentication credentials required for accessing external data sources. If a target API mandates authentication, the assigned Message Parsing Functional Entity (2200) retrieves the necessary credentials from the Authentication Functional Entity (2300) before execution.

Each Message Parsing Functional Entity (2200) is dedicated to a specific statistical data source. It executes the designated API, collects the raw data, and parses the response into a standardized format. The parsing process converts heterogeneous raw data into a generalized data model structure, which represents the statistical data in a uniform structure suitable for subsequent processing.

Once transformed, the generalized data model is transmitted to the Data Store Functions (3000), which store the structured data and make it available for further use within the framework. This modular design allows flexible extension to additional data sources by simply adding new Message Parsing Functional Entities (2200), thereby enhancing scalability while maintaining interoperability with the Data Governance Functions (1000).

### Data Storage Unit 300

The data storage unit 300 stores and manages statistical data in the data storage registry 500. When the data collection unit 200 generates a statistical data model and transmits the statistical data model to the central controller 100, the central controller 100 generates “column_header_checksum” on which a table in which corresponding statistical data will be stored may be checked.

The “column_header_checksum” may hash each “column_header_code”, and may generate each hash value by performing an XOR operation.

The central controller 100 checks whether the existing table in which data may be stored is present by transmitting the “column_header_checksum” to the data management unit 400. When the existing table is present, the central controller 100 assigns an identifier to statistical data and transmits the identifier to the data storage unit 300. When the existing table is not present, the central controller 100 generates a new table name and a dataflow identifier and then transmits the new table name and the dataflow identifier to the data storage unit 300 along with the statistical data. The data storage unit 300 stores the statistical data in a table designated by the central controller 100 and returns the results of the storage. If a corresponding table is not present, the data storage unit 300 generates a new table having a designated name in the data storage registry 500 based on the statistical data, and stores a statistical data object in the new table.

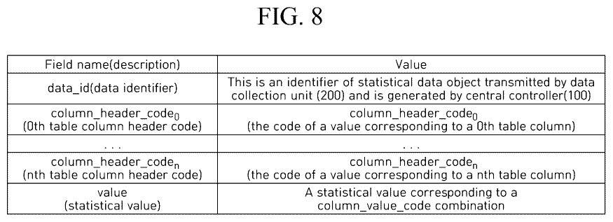

FIG. 8 illustrates a table structure that stores the statistics of the statistical data model and fields thereof. A table structure in which the column header of a statistical table and a value corresponding to each column are managed is the same as that of column_headers and column_values.

### Data Management Unit 400

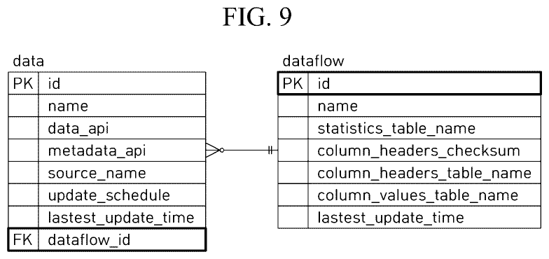

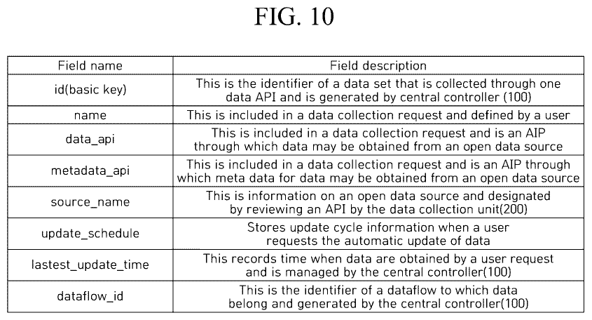

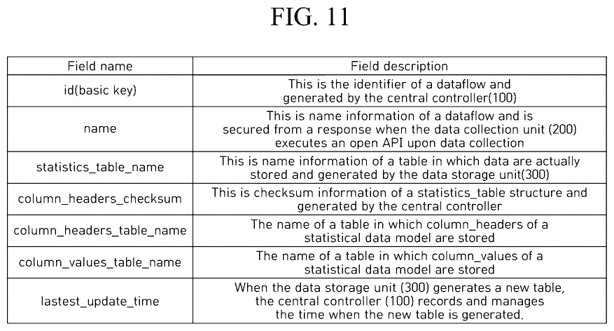

The data management unit 400 is responsible for a function for managing data requested by a user, and includes two objects “Data” and “Dataflow”. The object “Data” is a set of statistical data which may be obtained through one open API, and it is essentially connected to one object “Dataflow” and classifies and manages data. The object “Dataflow” are data that constitute meta data and share a value, and includes several data objects. The data management unit 400 performs the CRUD function on the data management registry 600 under the control of the central controller 100, and updates new information by considering a relational order between the objects “Data” and “Dataflow”. FIG. 9 illustrates a table structure of the data management registry 600 according to an embodiment of the present disclosure. FIG. 10 illustrates a description of the fields of a data table of the data management registry according to an embodiment of the present disclosure. FIG. 11 illustrates a description of the fields of a dataflow table of the data management registry according to an embodiment of the present disclosure.

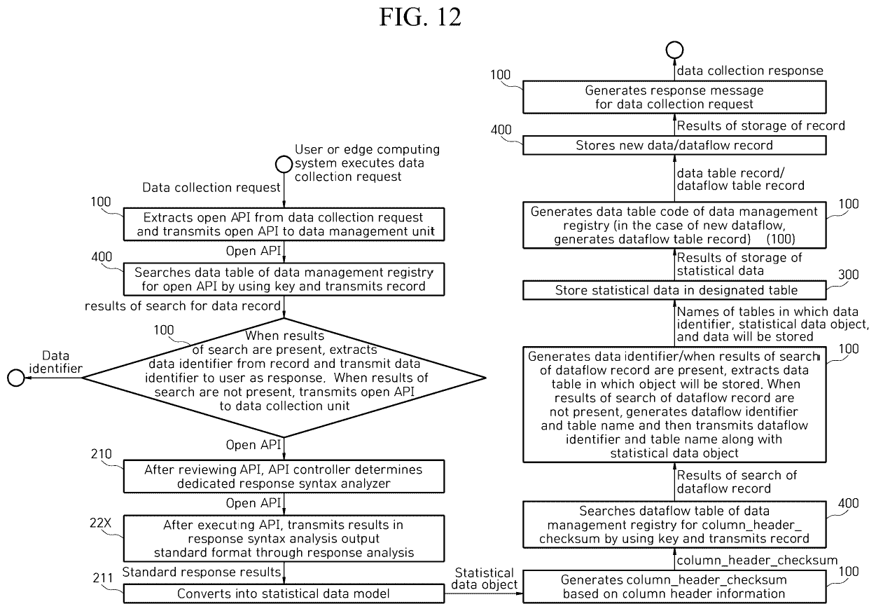

FIG. 12 illustrates a task execution process according to a data collection request according to an embodiment of the present disclosure.

When executing a data collection request, a user or an edge computing system extracts an open API from the data collection request and transmits the results of the extraction to the data management unit 400.

The data management unit 400 searches the data management registry 600 for an open API as a key and transmits a data object record (or NULL).

The central controller 100 extracts a data identifier from the record when a search path is present and transmits the data identifier to the user as a response, and transmits the open API to the data collection unit 200 when the results of the search are not present.

The API controller 210 of the data collection unit 200 reviews the open API and determines a dedicated response syntax analyzer.

The dedicated response syntax analyzer executes the open API, analyzes the response, and transmits a response syntax analysis output in a standard format.

The statistical data model converter 211 converts statistical data into a statistical data model based on standard information received from the response syntax analyzer, and generates a statistical data object.

The central controller 100 generates column_header_checksum based on column header information, searches the dataflow table of the data management registry 600 for the column_header_checksum as a key, and transmits a dataflow record.

The central controller 100 generates a data identifier, extracts a data table in which an object will be stored when the results of the search for the dataflow record are present, generates a dataflow identifier and a table name when the results of the search for the dataflow record are not present, and transmits the dataflow identifier and the table name along with the statistical data object.

The data storage unit 300 stores the statistical data in a designated table. The central controller 100 generates the data table record of the data management registry (generates a dataflow table record in the case of a new dataflow).

The data management unit 400 stores new data and the dataflow record. The central controller 100 generates a response message for the data collection request and provide the response message as a response.

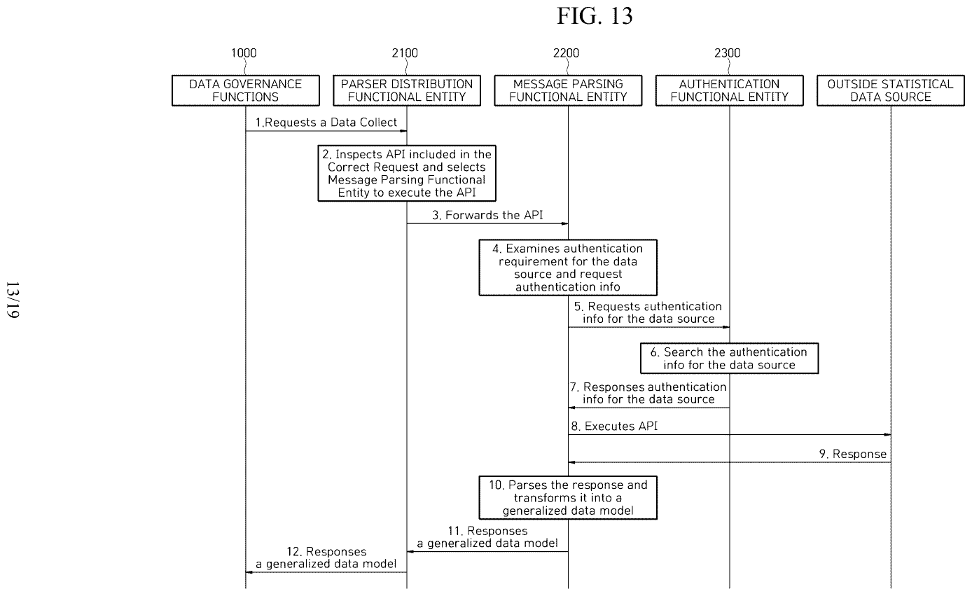

FIG. 13 illustrates a task execution process according to a data collect request.

The process involves interactions among the Data Governance Functions (1000), Parser Distribution Functional Entity (2100), the Message Parsing Functional Entity (2200), and the Authentication Functional Entity (2300).

The Data Governance Functions (1000) initiate a request to the Data Collect Functions (2000) to collect specific data from an external source. The request includes the API or URI required to retrieve the target data, and optionally, a metadata API if the source supports metadata retrieval.

The request is received by the Parser Distribution Functional Entity (2100), which inspects the API and determines the appropriate Message Parsing Functional Entity (2200) responsible for handling the designated data source.

The Parser Distribution Functional Entity (2100) forwards the API to the assigned Message Parsing Functional Entity (2200).

Upon receiving the API, the Message Parsing Functional Entity (2200) evaluates whether authentication is required to execute the API.

If authentication is required, the Message Parsing Functional Entity (2200) sends a request to the Authentication Functional Entity (2300), which manages authentication credentials for each data source.

The Authentication Functional Entity (2300) searches its repository for the corresponding credentials and returns the necessary authentication information, including the authentication type and key details.

With valid authentication, the Message Parsing Functional Entity (2200) executes the API call to the data source.

The external data source responds with the requested raw data.

The Message Parsing Functional Entity (2200) parses the response and converts the raw data into a generalized data model, ensuring a standardized representation regardless of source heterogeneity.

The generalized data model is returned to the Parser Distribution Functional Entity (2100).

Finally, the generalized data model is transmitted to the Data Governance Functions (1000), which can use it for further processing, storage, or analysis.

Through this structured procedure, FIG. 13 demonstrates how the framework enables secure, modular, and standardized data collection from diverse external sources, ensuring interoperability and scalability in a resource-constrained edge computing environment.

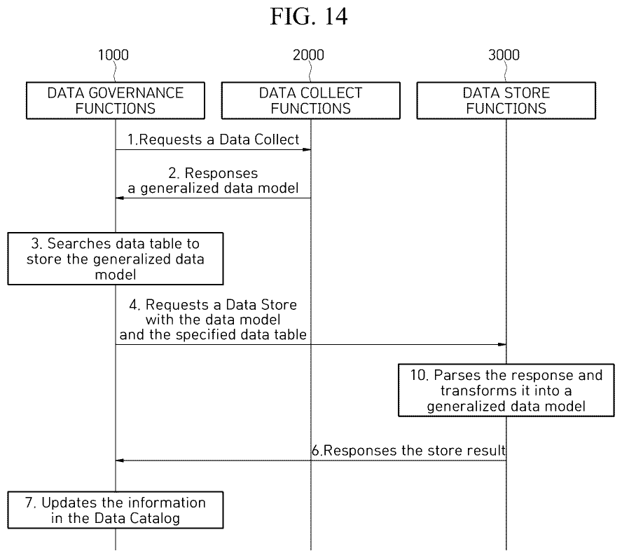

FIG. 14 illustrates a task execution process according to a data store request.

The Data Governance Functions (1000) initiate a request to the Data Collect Functions (2000) to collect specific data from an external source.

In response, the Data Collect Functions (2000) return the requested data in the form of a generalized data model, ensuring that heterogeneous data from external sources are transformed into a standardized format.

Upon receiving the generalized data model, the Data Governance Functions (1000) search for an existing physical data table suitable for storing the data model. If no appropriate table is found, the Data Governance Functions (1000) generate the necessary information to create a new data table.

The Data Governance Functions (1000) then send a data store request to the Data Store Functions (3000), specifying the generalized data model and details about the target data table.

The Data Store Functions (3000) store the data model into the designated data table as indicated in the request.

After storage is completed, the Data Store Functions (3000) return the storage result as a response to the Data Governance Functions (1000).

Once the storage of the new data is confirmed, the Data Governance Functions (1000) update the data catalog to reflect the addition. The data catalog maintains not only details about the stored data, but also metadata regarding the associated data tables and the history of data collection transactions.

Through this process, FIG. 14 demonstrates how the system ensures reliable storage of standardized data models, while enabling traceability and efficient management of stored resources within the data governance framework.

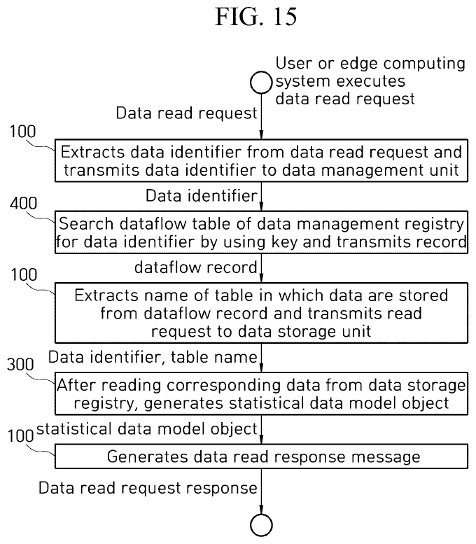

FIG. 15 illustrates a task execution process according to a data read request according to an embodiment of the present disclosure.

When executing a data read request, a user or an edge computing system extracts a data identifier from the data read request, and transmits the results of the extraction to the data management unit 400.

The data management unit 400 searches a dataflow table of the data management registry 600 for the data identifier as a key and transmits a dataflow record.

The central controller 100 extracts the name of a table in which data have been stored from the dataflow record, and transmits a read request to the data storage unit 300.

The data storage unit 300 reads corresponding data from the data storage registry 500 and generates a statistical data model object.

The central controller 100 receives the statistical data model object, generates a data read response message, and provides the data read response message as a response.

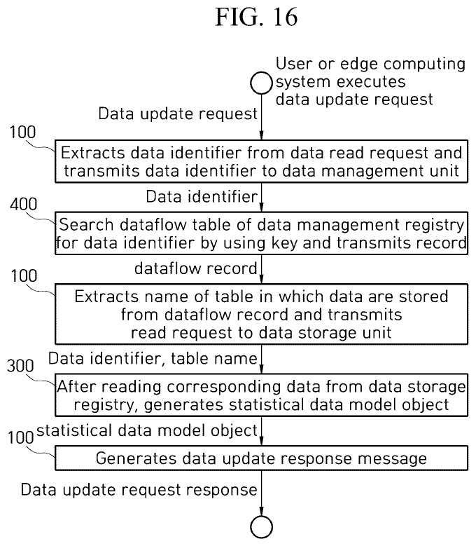

FIG. 16 illustrates a task execution process according to a data update request according to an embodiment of the present disclosure.

When executing a data update request, a user or an edge computing system extracts a data identifier from the data update request and transmits the results of the extraction to the data management unit 400.

The data management unit 400 searches the data table of the data management registry 600 for the data identifier by using a key, and transmits a data record.

The central controller 100 generates an update error message when the data record is not present, provides the user with the update error message, and extracts an open API from the data record when the search is successful.

After reviewing the open API, an API controller determines a response syntax analyzer. After executing the API, the response syntax analyzer performs response analysis, and transmits the results of a response syntax analysis output in a standard format.

When a statistical data model is constructed by using standard information, a statistical data object is generated.

The central controller 100 transmits the existing data identifier, a table name, and the newly generated statistical data object.

The data storage unit 300 performs statistical data update on a corresponding table of the data storage registry 500.

The central controller 100 generates the data table record of the data management registry 600.

The data management unit 400 updates the data table record. The central controller 100 generates and provides a response to the data update request.

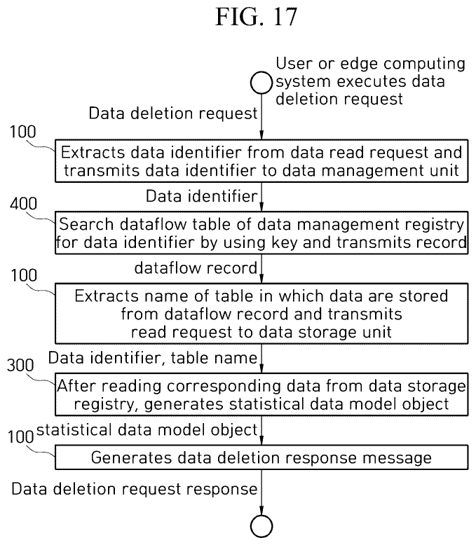

FIG. 17 illustrates a task execution process according to a data deletion request according to an embodiment of the present disclosure.

When executing a data deletion request, a user or an edge computing system extracts a data identifier from the data deletion request and transmits the results of the extraction to the data management unit 400.

The data management unit 400 searches the data table of the data management registry 600 for the data identifier by using a key, and transmits a data record.

The central controller 100 generates a deletion error message when the data record is not found, transmits the deletion error message to the user, and transmits a dataflow identifier to the data management unit 400 when the search is successful.

The data management unit 400 receives the dataflow identifier, searches the dataflow table of the data management registry 600 for the dataflow identifier by using a key, and transmits a dataflow object record.

The central controller 100 secures the names of tables “statistics_table”, “column_headers_table”, and “column_attributes” from the dataflow record, and transmits the data identifier and the table names to the data storage unit 300.

The data storage unit 300 deletes the data record in the table “statistics_table” of the data storage registry 500 by using the data identifier as a key, and deletes the tables “column_headers_table” and “column_attributes” when the data record is not present in the table “statistics_table”.

The central controller 100 receives the results of the deletion, transmits a record deletion request to the data table of the data management unit 400, and performs a dataflow object deletion request if the table is also deleted.

The data management unit 400 deletes a corresponding record in the data table of the data management registry 600 by using the data identifier as a key.

The central controller 100 receives the results of the record deletion, and generates and provides a data deletion response.

Hereinafter, a detailed user scenario of the system according to an embodiment of the present disclosure is described.

A user tries to secure the data of quarterly real GDP growth rates of Republic of Korea and the USA from the OECD Data Explorer and to update the data every 720 hours. First, the user accesses the OECD Data Explorer web service (https://data-explorer.oecd.org/) and finds the data sets of Quarterly National Accounts (for “Developer API”) including GDP data of several countries. The user sets parameters regarding the data sets through a dashboard that is provided by the OECD Data Explorer and searches for the data of the quarterly real GDP growth rate of Republic of Korea. The user checks the corresponding data and secures an API for the data and an API for meta data. The user sets data set parameters again and secures an API for corresponding data and an API for meta data by searching for the data of the real GDP growth rate of the USA. The two data have the same API for the meta data because the two data are included in the same data set. The user transmits a collection request for the data of the real GDP growth rate of each of Republic of Korea and the USA to the system according to an embodiment of the present disclosure, and receives responses from the system.

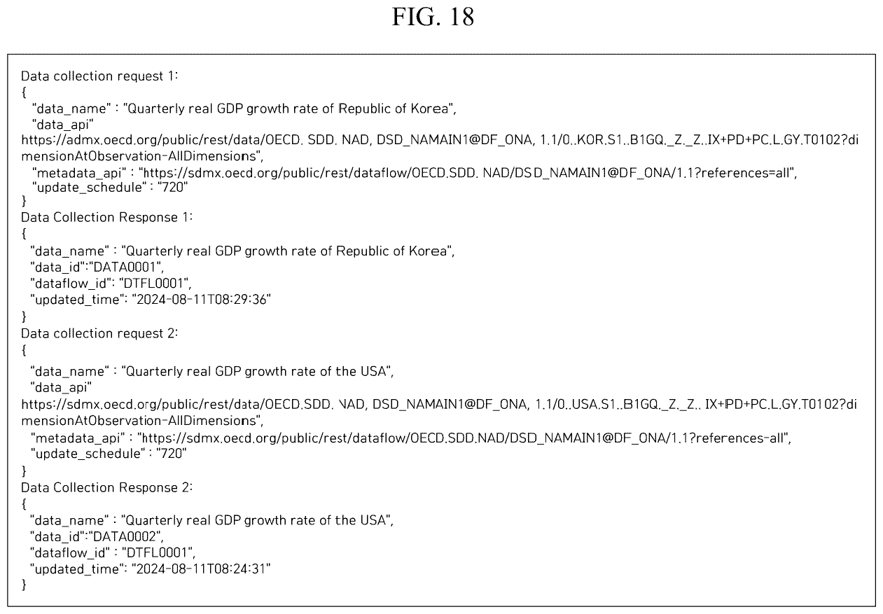

FIG. 18 illustrates a data collection request and system response of a user scenario according to an embodiment of the present disclosure. A user transmits a read request for each datum in order to secure requested data and receives statistical data. Table 1 illustrates a data collection request and a system response for a user scenario according to an embodiment of the present disclosure. Referring to Table 1, two time-series data are indicated in Table 1, and the indication of the remaining parts are omitted.

```
TABLE 1
data read request1:
{
“data_id” : “DATA0001”,
}
data read response1:
{
  ″result″: true,
  ″data_id″: ″DATA000001″,
  ″update_time″: ″2024-09-23 15:54:54″,
  ″data″: [
    {
      ″value″: ″145994700″,
      ″metadata″: [
        {
          ″Frequency of observation″: ″Annual″
        },
        {
          ″Reference area″: ″Korea″
        },
        {
          ″Institutional sector″: ″Total economy″
        },
        {
          ″Counterpart institutional sector″: ″Total economy″
        },
        {
          ″Transaction″: ″Gross domestic product″
        },
        {
          ″Financial instruments and non-financial assets″: ″Not applicable″
        },
        {
          ″Economic activity″: ″Not applicable″
        },
        }
          ″Expenditure″: ″Not applicable″
        },
        {
          ″Unit of measure″: ″National currency″
        },
        {
          ″Price base″: ″Current prices″
        },
        {
          ″Transformation″: ″Non transformed data″
        },
        {
          ″Table identifier″: ″Table 0102 - GDP identity from the expenditure side″
        },
        {
          ″time_period″: ″1988″
        },
        {
          ″Price reference year″: null
        },
        {
          ″Confidentiality status″: ″Free (free for publication)″
        },
        {
          ″Decimals″: ″One″
        },
        {
          ″Observation status″: ″Normal value″
        },
        {
          ″Unit multiplier″: ″Millions″
        },
        {
          ″Currency″: ″Won″
        }
      ]
    },
    {
      ″value″: ″165801800″,
      ″metadata″: [
        {
          ″Frequency of observation″: ″Annual″
        },
        {
          ″Reference area″: ″Korea″
        },
        {
          ″Institutional sector″: ″Total economy″
        },
        {
          ″Counterpart institutional sector″: ″Total economy″
        },
        {
          ″Transaction″: ″Gross domestic product″
        },
        {
          ″Financial instruments and non-financial assets″: ″Not applicable″
        },
        {
          ″Economic activity″: ″Not applicable″
        },
        {
          ″Expenditure″: ″Not applicable″
        },
        {
          ″Unit of measure″: ″National currency″
        },
        {
          ″Price base″: ″Current prices″
        },
        {
          ″Transformation″: ″Non transformed data″
        },
        {
          ″Table identifier″: ″Table 0102 - GDP identity from the expenditure side″
        },
        {
          ″time_period″: ″1989″
        },
        {
          ″Price reference year″: null
        },
        {
          ″Confidentiality status″: ″Free (free for publication)″
        },
        {
          ″Decimals″: ″One″
        },
        {
          ″Observation status″: ″Normal value″
        },
        {
          ″Unit multiplier″: ″Millions″
        },
        {
          ″Currency″: ″Won″
        }
      ]
    },
  ...
  ]
}
data read request2:
{
″data_id″ : ″DATA0002″,
}
data read response2:
{
  ″result″: true,
  ″data_id″: ″DATA000002″,
  ″update_time″: ″2024-09-23 15:54:58″,
  ″data″: [
    {
      ″value″: ″413320000″,
      ″metadata″: [
        {
          ″Frequency of observation″: ″Annual″
        },
        {
          ″Reference area″: ″Korea″
        },
        {
          ″Institutional sector″: ″Total economy″
        },
        {
          ″Counterpart institutional sector″: ″Total economy″
        },
        {
          ″Transaction″: ″Gross domestic product″
        },
        {
          ″Financial instruments and non-financial assets″: ″Not applicable″
        },
        {
          ″Economic activity″: ″Not applicable″
        },
        {
          ″Expenditure″: ″Not applicable″
        },
        {
          ″Unit of measure″: ″National currency″
        },
        {
          ″Price base″: ″Chain linked volume″
        },
        {
          ″Transformation″: ″Non transformed data″
        },
        {
          ″Table identifier″: ″Table 0102 - GDP identity from the expenditure side″
        },
        {
          ″time_period″: ″1989″
        },
        {
          ″ref_year_price″: ″2015″
        },
        {
          ″Confidentiality status″: ″Free (free for publication)″
        },
        {
          ″Decimals″: ″One″
        },
        {
          ″Observation status″: ″Normal value″
        },
        {
          ″Unit multiplier″: ″Millions″
        },
        {
          ″Currency″: ″Won″
        }
      ]
    },
    {
      ″value″: ″454145900″,
      ″metadata″: [
        {
          ″Frequency of observation″: ″Annual″
        },
        {
          ″Reference area″: ″Korea″
        },
        {
          ″Institutional sector″: ″Total economy″
        },
        {
          ″Counterpart institutional sector″: ″Total economy″
        },
        {
          ″Transaction″: ″Gross domestic product″
        },
        {
          ″Financial instruments and non-financial assets″: ″Not applicable″
        },
        {
          ″Economic activity″: ″Not applicable″
        },
        {
          ″Expenditure″: ″Not applicable″
        },
        {
          ″Unit of measure″: ″National currency″
        },
        {
          ″Price base″: ″Chain linked volume″
        },
        {
          ″Transformation″: ″Non transformed data″
        },
        {
          ″Table identifier″: ″Table 0102 - GDP identity from the expenditure side″
        },
        {
          ″time_period″: ″1990″
        },
        {
          ″ref_year_price″: ″2015″
        },
        {
          ″Confidentiality status″: ″Free (free for publication)″
        },
        {
          ″Decimals″: ″One″
        },
        {
          ″Observation status″: ″Normal value″
        },
        {
          ″Unit multiplier″: ″Millions″
        },
        {
          ″Currency″: ″Won″
        }
      ]
    },
  ...
  ]
}
```

The method of collecting and managing public statistical data in the resource-constrained environment according to an embodiment of the present disclosure includes steps of (a) setting a control path within the system for system requests, executing an API for collecting data from an open data source, redefining meta data through received data analysis, and performing data model conversion and (b) performing processing on the system requests including data collection, read, update, and deletion and providing a response to a user.
Step (a) includes reviewing an open API including a data API and a meta data API, determining a response syntax analyzer that will process the response, and constructing a statistical data model by using field information of the meta data.
Step (b) includes performing search on the data management registry by using the open API as a key upon system request for the data collection, generating a data identifier for a statistical data object, and storing the statistical data object.
Step (b) includes extracting a data identifier upon system request for the data read, performing key search, extracting the name of a table from a dataflow object record, and generating a response message to the read request.
Step (b) includes extracting a data identifier upon system request for the data update, performing key search, searching for a data object record, checking the name of a table in a dataflow object record, and updating statistical data.
Step (b) includes extracting a data identifier upon system request for the data deletion, performing key search, searching for a data object record, checking a table name in a dataflow object record, and performing record deletion by using the data identifier and a dataflow identifier as a key.

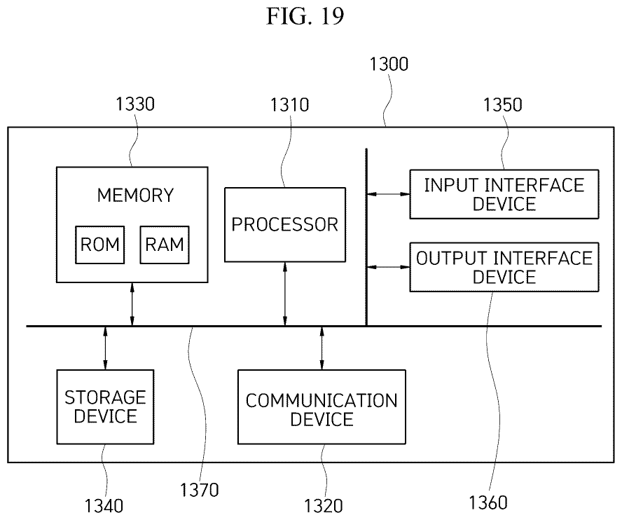

FIG. 19 is a block diagram illustrating a computer system for implementing a method according to an embodiment of the present disclosure.

Referring to FIG. 19, the computer system 1300 may include at least one of a processor 1310, memory 1330, an input interface device 1350, an output interface device 1360, and a storage device 1340 which communicate with each other through a bus 1370. The computer system 1300 may further include a communication device 1320 connected to a network. The processor 1310 may be a central processing unit (CPU) or may be a semiconductor device that executes instructions stored in the memory 1330 or the storage device 1340. The memory 1330 and the storage device 1340 may each include various types of volatile or nonvolatile storage media. For example, the memory may include read only memory (ROM) and random access memory (RAM). In an embodiment of the present specification, the memory may be disposed inside or outside the processor and connected to the processor through various known means. The memory includes various types of volatile or nonvolatile storage media, and may include ROM or RAM, for example.

Accordingly, an embodiment of the present disclosure may be implemented as a method implemented in a computer or may be implemented as a non-transitory computer-readable medium in which a computer-executable instruction has been stored. In an embodiment, when being executed by a processor, a computer-readable instruction may perform a method according to at least one aspect of this writing.

The communication device 1320 may transmit or receive a wired signal or a wireless signal.

Furthermore, the method according to an embodiment of the present disclosure may be implemented in the form of a program instruction which may be executed through various computer means, and may be recorded on a computer-readable medium.

The computer-readable medium may include a program instruction, a data file, and a data structure alone or in combination. A program instruction recorded on the computer-readable medium may be specially designed and constructed for an embodiment of the present disclosure or may be known and available to those skilled in the computer software field. The computer-readable medium may include a hardware device configured to store and execute the program instruction. For example, the computer-readable medium may include magnetic media such as a hard disk, a floppy disk, and a magnetic tape, optical media such as CD-ROM and a DVD, magneto-optical media such as a floptical disk, ROM, RAM, and flash memory. The program instruction may include not only a machine code produced by a compiler, but a high-level language code capable of being executed by a computer through an interpreter.

The embodiments of the present disclosure have been described in detail, but the scope of rights of the present disclosure is not limited thereto. A variety of modifications and changes made by those skilled in the art using the basic concept of the present disclosure defined in the appended claims are also included in the scope of rights of the present disclosure.

What is claimed is:

1. A system for collecting and managing public statistical data in a resource-constrained environment, the system comprising:
a central controller configured to process a system request and to set a control path within the system;
a data collection unit configured to collect data from an open data source and to generate statistical data information by analyzing a response;
a data storage unit configured to store a statistical data object in a data storage registry; and
a data management unit configured to perform data management based on a system request and to manage a data management registry.

2. The system of claim 1, wherein the data collection unit executes an API for collecting data from the open data source, redefines meta data through received data analysis, and performs data model conversion.

3. The system of claim 2, wherein the data collection unit receives an open API comprising a data API and a meta data API from the central controller.

4. The system of claim 2, wherein the data collection unit determines a response syntax analyzer that is fully responsible for a corresponding data source by reviewing the API.

5. The system of claim 4, wherein:
the data collection unit constructs a statistical data model based on standard information received from the response syntax analyzer, and
the statistical data model comprises a table in which a column header, a column value indicative of a value of attributes of data, and a statistical value corresponding to a combination of column values corresponding to each column header are stored.

6. The system of claim 1, wherein the data storage unit checks and stores a table in which the statistical data object is able to be stored by reviewing a data table, returns a name of the table in which the statistical data object is stored, generates a new table in the data storage registry based on a structure of the statistical data object if a table in which the statistical data object is able to be stored is not present, and stores the statistical data object in the new table.

7. A method of collecting and managing public statistical data in the resource-constrained environment, which is performed by a system for collecting and managing public statistical data in a resource-constrained environment, the method comprising:
(a) setting a control path within the system for system requests, executing an API for collecting data from an open data source, redefining meta data through received data analysis, and performing data model conversion; and
(b) performing processing on the system requests comprising data collection, read, update, and deletion and providing a response to a user.

8. The method of claim 7, wherein the step (a) comprises reviewing an open API comprising a data API and a meta data API, determining a response syntax analyzer that is to process the response, and constructing a statistical data model by using standard information received from the response syntax analyzer.

9. The method of claim 8, wherein the step (b) comprises searching a data table of the data management registry for the open API by using a key upon system request for the data collection, generating a data identifier for a statistical data object, and storing the statistical data object.

10. The method of claim 8, wherein the step (b) comprises extracting a data identifier upon system request for the data read, performing key search, extracting a name of a table from a dataflow record, and generating a response message to a read request.

11. The method of claim 8, wherein the step (b) comprises extracting a data identifier upon system request for the data update, performing key search, searching for a data record, checking a name of a table in a dataflow record, and updating statistical data.

12. The method of claim 8, wherein the step (b) comprises extracting a data identifier upon system request for the data deletion, performing key search, searching for a data record, checking a name of a table in a dataflow record, and performing record deletion by using the data identifier and the dataflow identifier as a key.

13. A system for collecting and managing public statistical data in a resource-constrained environment, the system comprising:
Data Governance Functions configured to initiate data collection requests, manage metadata, and update a data catalog;
Data Collect Functions comprising a Parser Distribution Functional Entity, one or more Message Parsing Functional Entities, and an Authentication Functional Entity, the Data Collect Functions being configured to receive an API from the Data Governance Functions, validate the API, perform authentication when required, and parse raw data from an external source into a generalized data model; and
Data Store Functions configured to store the generalized data model in a designated data table and return storage results to the Data Governance Functions.

14. The system of claim 13, wherein the Parser Distribution Functional Entity inspects an API contained in the data collection request and assigns the API to a Message Parsing Functional Entity dedicated to a specific data source.

15. The system of claim 13, wherein the Authentication Functional Entity manages and stores authentication credentials for each data source and provides the credentials to the Message Parsing Functional Entity when authentication is required.

16. The system of claim 13, wherein the Message Parsing Functional Entity executes the assigned API, receives raw data from the external data source, and parses the raw data into the generalized data model.

17. The system of claim 13, wherein the generalized data model comprises column headers, column values corresponding to the column headers, and statistical values representing a combination of the column values.

18. The system of claim 13, wherein the Data Governance Functions determine whether a suitable data table exists for storing the generalized data model, generate a new table when no suitable table exists, and store the generalized data model in the generated table.

19. The system of claim 13, wherein the Data Governance Functions update the data catalog to reflect information about the stored generalized data model, including metadata of the data and details of the data table.
